(19) United States
(12) Patent Application Publication
(10) Pub. No.: US 2016/0065526 A1
(43) Pub. Date: Mar. 3, 2016

(54) CONVEY MESSAGE ANONYMOUSLY AND DISCREETLY

(71) Applicant: SREEDHAR LAGADAPATI, SAN RAMON, CA (US)

(72) Inventor: SREEDHAR LAGADAPATI, SAN RAMON, CA (US)

(21) Appl. No.: 14/937,717

(22) Filed: Nov. 10, 2015

Related U.S. Application Data
(60) Provisional application No. 62/200,100, filed on Aug. 2, 2015.

(51) Int. Cl. H04L 12/58

(52) U.S. Cl. CPC H04L 51/22; H04L 51/04

(57) ABSTRACT

Convey Message Anonymously and Discreetly is an exclusive social network that allows people to connect with others, recognize their actions and offer genuine advice to members in the network. It achieves this by granting users the option of mentioning the place, time and describing the individual, and event in detail.

Disclosed is a method for conveying one or messages anonymously and discretely. Using the method, a user provides one or more indicia of Date and Time Stamp, Location, Message Type, and Personal Demographics along with a narrative regarding a person about whom the indicia of demographics describe. The indicia and narrative are posted on an Internet connected computer server for others to read.

### CROSS-REFERENCE TO RELATED APPLICATION

This application claims the benefit of priority of U.S. Provisional Patent Application 62/200,100 filed Aug. 19, 2015 and titled “CONVEY MESSAGE ANONYMOUSLY AND DISCRETELY,” the disclosure of which is incorporated by reference.

### STATEMENT REGARDING FEDERALLY SPONSORED RESEARCH OR DEVELOPMENT

Not Applicable

### BACKGROUND OF THE INVENTION

1. Field of Invention

The invention relates generally to the field of social media and more specifically to methods of posting messages anonymously and discreetly.

2. Description of Related Art

Social media has created an evolution of textual postings about a plethora of topics, along with many billions of images and videos. Yet seemingly none of them have a way to thank a kind stranger or make a kind statement both anonymously and discreetly.

### SUMMARY OF THE INVENTION

Disclosed is a method for conveying a message anonymously and for discreetly initiating a conversation between two or more people.

Using the method, a user provides one or more indicia (i.e., message tags) of a date and time, a location, a message type, and a message. In some embodiments a user may also provide additional indicia of personal details. The indicia and the message are posted on an Internet connected computer server for others to read.

The indicia of location may include a municipal location, business location, street address or other indicia of location.

The indicia of message type may include appreciation, re-connect, suggestion, observation, alert, or other indicia of message type.

The indicia of personal details may include gender, race, height, weight, age, complexion, or other indicia of personal demographics.

The method may include posting an access question having an answer to which only the poster and the person about whom the message regards know the answer for the purpose of excluding the public from further details or responding to the message.

The posting may be openly accessible to the public or accessible only to select people.

The posting may be anonymous by the use of a pseudonym or the absence of a username.

The posting may be discreet through the use of message access verification.

Another user may see the posting, and on wishing to engage in conversation with the posting user or to reply to the posting, the replying user may need to submit a qualifying access answer to an access question posted with the posting.

### BRIEF DESCRIPTION OF THE DRAWINGS

FIG. 1 shows a Body of Text Transmission System (100) according to an exemplary embodiment of the method.

FIG. 02 depicts a Text System (200) in accordance with an embodiment of the method to Convey a Message Anonymously and Discreetly.

FIGS. 3A, 3B, 3C, 3D, 3E and 3F show an exemplary electronic display output to prompt receipt of a plurality of message tags for collecting indicia to conveying a message anonymously and for discreetly initiating a conversation between two or more people.

FIGS. 4A, 4B and 4C show instructions that when executed by the at least one Processing Device (220) cause the system to receive the message tags and body of text for the method.

FIGS. 5A, 5B and 5C show instructions that when executed by the at least one Processing Device (220) cause the system to store the message tags and body of text for the method in the at least one non-transitory storage medium.

FIGS. 6A, 6B and 6C show instructions that when executed by the at least one Processing Device (220) cause the system to output through a body of text electronic distribution network for public display the message tags and body of text for the method.

FIG. 7A shows an embodiment in which instructions that when executed by the at least one Processing Device (220) cause the system to acquire the geolocation of the input device from the Global Positioning System hardware within the input device and to populate the message tags for a City, a State, and a Country.

FIG. 7B shows an embodiment in which instructions that when executed by the at least one Processing Device (220) cause the system to acquire the geolocation of the input device from an initial entry of a message tag for a City (320), and then display a plurality of States and Country message tags having in common the name of the entered City, from which a user may select the State and Country.

FIG. 8 shows an embodiment in which instructions that when executed by the at least one Processing Device (220) causes the system to use message access verification.

FIGS. 9A, 9B and 9C show exemplary postings created from the method.

### DETAILED DESCRIPTION OF THE INVENTION

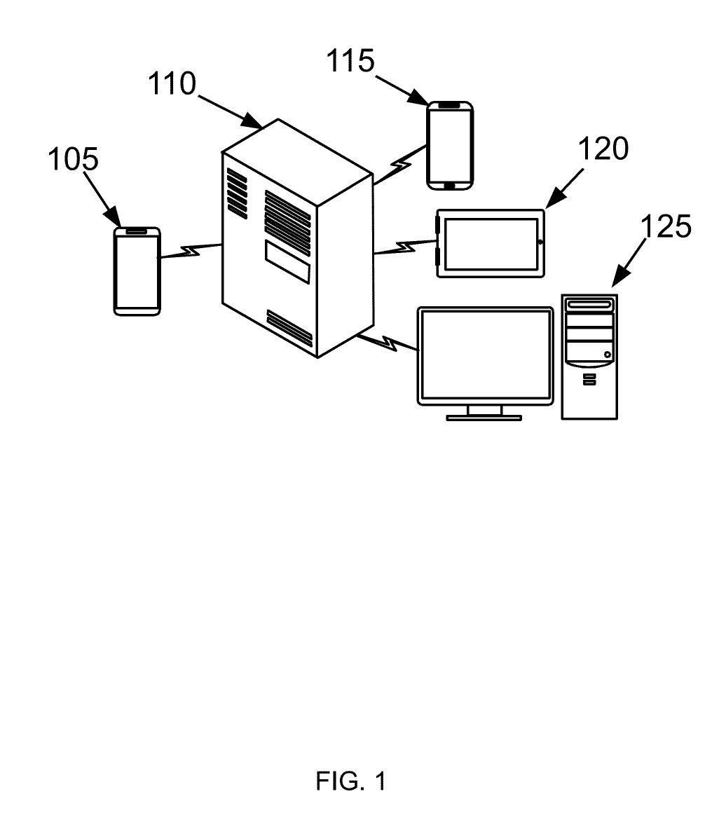

FIG. 1 shows a Body of Text Transmission System (100) according to an exemplary embodiment of the method.

The Body of Text Transmission System (100) may include a Body of Text Creation and Display Device (105), one or more Servers (110), and a plurality of other Body of Text Creation and Display Device (115), (120), (125), etc.

The Body of Text Creation and Display Device (105) may be a smart phone, or as provided by way of example as with the other Body of Text Creation and Display Device (115), (120), (125), etc., the Body of Text Creation and Display Device (105) may be tablet personal computer (PC), a notebook PC, a mobile phone, a desktop PC, a smart television (TV), etc. The common aspect to all Body of Text Creation and Display Device is the ability to create and display a Body of Text, along with the ability to transmit and receive a Body of Text according to the method.

Above all, the Body of Text Creation and Display Device (105), etc., maintains a transmission mode to transmit and receive a Body of Text according to the method.

In some embodiments, a Body of Text is created by a user on the Body of Text Creation and Display Device (105) by way of a mechanical keyboard installed on the Body of Text Creation and Display Device (105). In some embodiments, a Body of Text is created by a user on the Body of Text Creation and Display Device (105) by way of a virtual keyboard installed on the Body of Text Creation and Display Device (105).

In some embodiments, a Body of Text is transmitted, received, or both via one or more of the communication networks on the Body of Text Creation and Display Device (105), e.g., a Body of Text could be received via a short message service, i.e., a text message.

After creation of the Body of Text, the Body of Text Creation and Display Device (105) transmits the created Body of Text to the one or more Servers (110). The one or more Servers (110) then process the Body of Text according to the method as discussed herein. The one or more Servers (110) then transmits the Body of Text processed according to the method through the one or more Servers (110) to the other Body of Text Creation and Display Device (115), (120), (125), etc.

Though only one each is shown of a Body of Text Creation and Display Device (105), one or more Servers (110), and a plurality of other Body of Text Creation and Display Device (115), (120), (125), etc., the method may accommodate many of a Body of Text Creation and Display Device (105), one or more Servers (110), and a plurality of other Body of Text Creation and Display Device (115), (120), (125), etc.

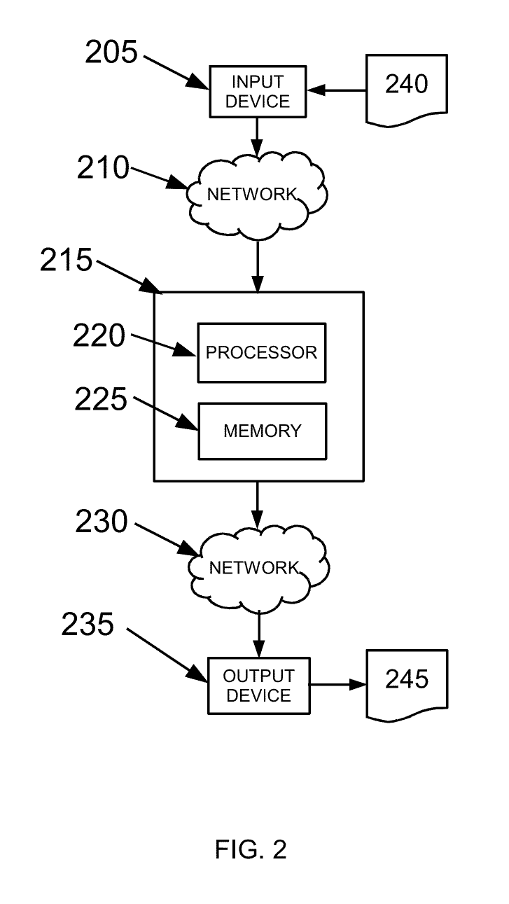

FIG. 02 depicts a Text System (200) in accordance with an embodiment of the method to Convey a Message Anonymously and Discreetly.

Shown in FIG. 2 are a Text Input Device (205), a Text Input Network (210), a Server (215), at least one Processing Device (220), a Memory Device (225) representing at least one non-transitory storage medium, a Text Output Network (230), a Text Output Device (235), a Body of Text Input (240) and a Body of Text Output (245).

Text System (200) is a generalized illustration in that other components may be added or existing components may be removed, modified, or rearranged without departing from the scope of the Text System (200).

The Text System (200) is generally the resource that receives, stores, and distributes a Body of Text, including the plurality of message tags, and messages disclosed herein.

For the purposes of simplicity in illustration, the various system components are shown as separate devices. It should be understood, however, that one or more system components may be integrated with one another. For example, the Server (215) may be integrated with the Text Input Network (210), the Text Output Network (230), or both. In another example, the Text Input Network (210) and the Text Output Network (230) may be the same network.

Furthermore, for ease of understanding, only one component of each structure is shown. There may be in fact more than one of the same component, e.g., while only one Server (215) is shown, more than one server may be used.

In one embodiment, this Text System (200) may be one or more web servers that host the instructions, plurality of message tags, and messages disclosed herein. In another embodiment, the Text System (200) may be a database that stores the instructions, plurality of message tags, and messages disclosed herein. In yet another embodiment, the Text System (200) may be a storage medium that stores one or both of files and previously harvested textual data. For example, the storage medium may be a flash drive, hard drive, disk drive, CD-ROM, or the like with text stored thereon.

The Text System (200) may provide a Body of Text, e.g., the Body of Text Input (240) or the Body of Text Output (245) or both, directly or indirectly to the Server (215). For example, the Text System (200) may provide the Body of Text Input (240) or the Body of Text Output (245) or both indirectly via the Text Input Network (210), or directly via a port connection. The Text System (200) may also provide the Body of Text Input (240) or the Body of Text Output (245) or both as one or more of continuously, periodically, and on-demand data. In some embodiments, the Body of Text Input (240) or the Body of Text Output (245) or both is provided in real-time as the Body of Text Input (240) or the Body of Text Output (245) or both is created. For example, the Text System (200) may provide real time messages from users as they are added by users.

The Text Input Network (210) and Text Output Network (230) may be a typical communication networks that enables the communication of data. For example, the Text Input Network (210) and Text Output Network (230) may one or more networks including, but not limited to one or more or wired/wireless networks, local area networks (LANs), wide area network (WANs), telecommunication networks, the Internet, an Intranet, computer networks, Bluetooth networks, Ethernet LANs, token ring LANs, Inter-Integrated Circuit (I2C) networks, serial advanced technology attachment (SATA) networks, and serial attached SCSI (SAS) networks. Such networks may utilize one or more of transmission mediums including, but not limited to, copper, fiber optics, coaxial, unshielded twisted pair, shielded twisted pair, heliax, radio frequency (RF), infrared (IR), and microwave.

The Server (215) is generally one or more computing devices configured to retrieve, obtain, and/or ingest textual data from the Text System (200) and process such data. The Server (215) comprises at least one Processing Device (220) (e.g., CPUs, microprocessors, microcontrollers, processors, etc.) and the Memory Device (225) (e.g., RAM, ROM, cache, etc). Executable instructions stored on the Memory Device (225) may be executed by the at least one Processing Device (220) to conduct the various server functions described herein.

In some embodiments, the Server (215) provides a “cloud” service, where features provided by the Server (215) may be accessible by one or more remote computing devices via network connections. In other embodiments, the Server (215) provides a “local” service, where a user's computing device comprises the Server (215) and Text Output Device (235), and services provided by the server are accessible by the user's computing device.

The Text Output Device (235) is generally a device configured to receive and display information. In some embodiments, the Text Output Device (235) may comprise a display connected to the Server (215). While in other embodiments, the Text Output Device (235) may comprise one or more of a computing device including but not limited to a laptop computer, a desktop computer, tablet, a smartphone, or other network enabled device connected to the Server (215) via Text Output Network (230).

Turning now to Text System (200) operations, as mentioned, the Text System (200) enables a Body of Text Input (240) or a Body of Text Output (245) or both to be received, processed and distributed. This may be accomplished in some embodiments through the use of devices within the Server (215) to receive or pull the Body of Text Input (240) from the Text Input Device (205), and to send or push the Body of Text Output (245) to the Text Output Device (235). While one Text Input Device (205) and one Text Output Device (235) are shown, these are merely representative as there may be a plurality of Text Input Devices (205) and Text Output Devices (235).

A Body of Text Input (240) may be processed by the at least one Processing Device (220) in various manners as described herein.

A Body of Text Input (240) may be stored by the Memory Devices (225) in various manners as described herein.

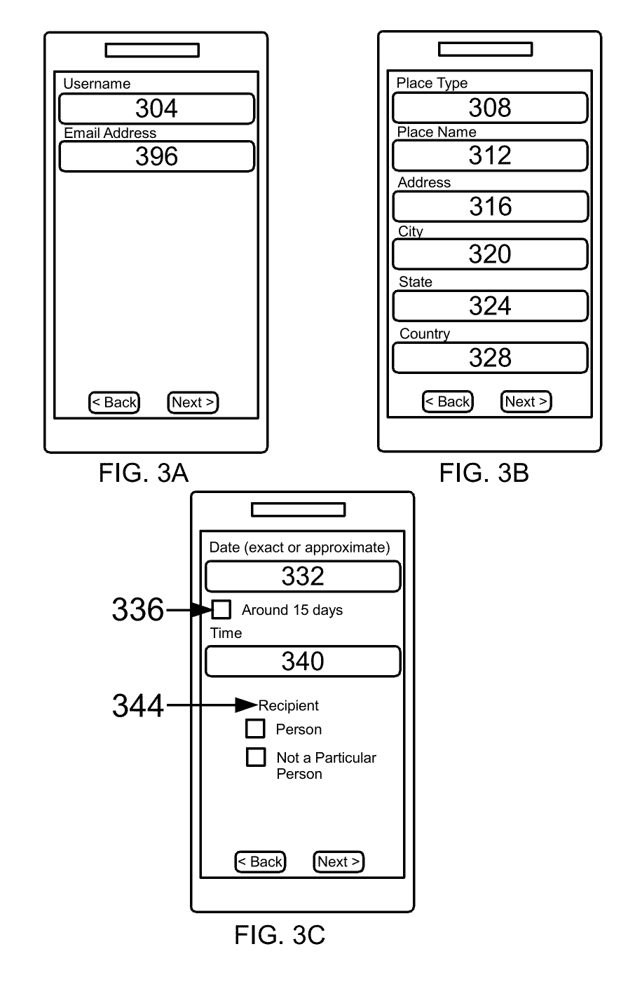

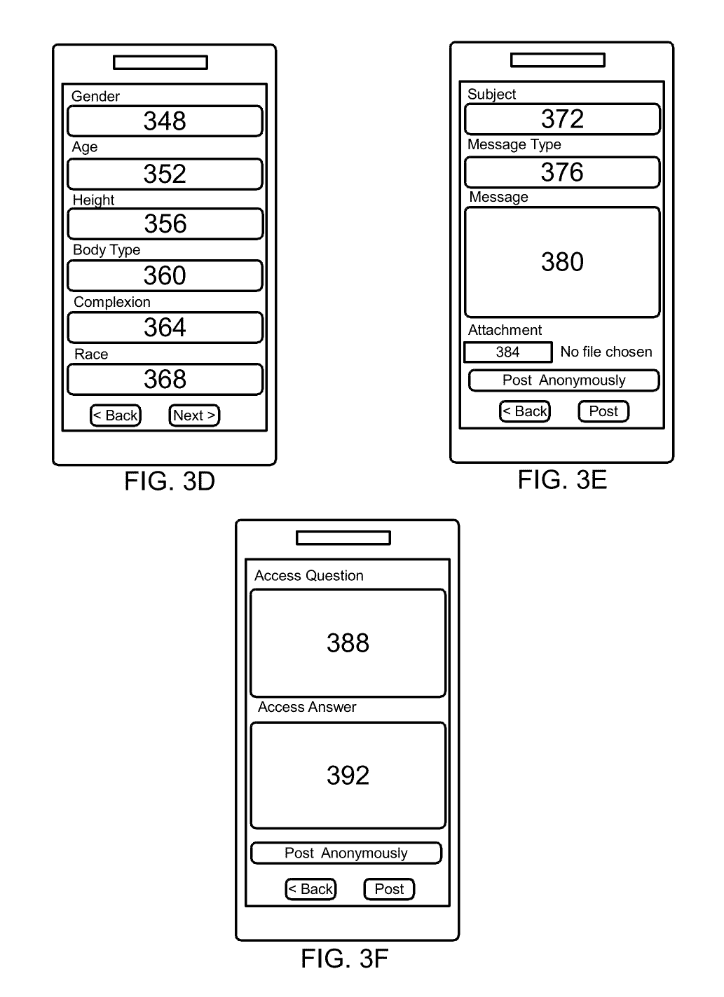

FIGS. 3A, 3B, 3C, 3D, 3E and 3F show an exemplary electronic display output to prompt receipt of a plurality of message tags for collecting indicia to conveying a message anonymously and for discreetly initiating a conversation between two or more people.

Show in FIG. 3A are fields for collecting a username (304) and an email address (396), which may be used, along with a password (not shown), in some embodiments for a user to create an account. The username (304) may be a pseudonym for anonymous posting, or a user may use the user real name if an anonymous posting is not desired. The email address (396) provides a point of contact to the person posting the message so that the person posting the message may receive a notice that their intended recipient has received the message and desires to have a two-way conversation. In an anonymous posting, the email address (396) may be omitted.

Show in FIG. 3B are fields for a Place Type (308), a Place Name (312), an Address (316), a City (320), a State (324), and a Country (328).

An electronic display output prompts entry of a message tag for a Place Type (308) regarding the message to be conveyed. In some embodiments, the Place Type may include “Coffee Shop”, “at the corner of”, “Internet Café”, or Other. In some embodiments, the Place Type may include be “In Transit”, “In the train”, “In flight”, “In bus” or a similar in transit statement. The a message tag for a Place Type (308) may be “Electronics Store”, “Food”, “Freeway”, “Function Hall”, “Furniture Store”, “Gas Station”, “Golf Course”, “Grocery Store”, “Gym”, “Hair Salon”, “Hardware Store”, “Hospital”, “Hotel”, “In Bus”, “In Cruise”, “In Flight”, “In Train”, “In Ferry”, “Jewelry Shop”, “Laundry”, “Library”, “Liquor Store”, “Local Road”, “Miniature Golf”, “Movie Theater”, “Motel”, “Museum”, “Night Club”, “Outlet Mall”, “Park”, “Parking”, “Pet Store”, “Pharmacy”, “Embassy”, “Department”, “Store”, “Consignment Store”, “Courthouse”, “Convenience Store”, “Clothing Store”, “City Hall”, “Casino”, “Car Wash”, “Car Service”, “Car Rental”, “Car Dealer”, “Campground”, “Cafe”, “Bowling Alley”, “Book Store”, “Beauty Salon”, “Bus Station”, “Bus Stop”, “Bar”, “Bakery”, “Aquarium”, “Amusement Park”, “Airport”, “Post Office”, “Restaurant”, “RV Park”, “School”, “Shoe Store”, “Spa”, “Stadium”, “Subway Station”, “Shopping Mall”, “Sporting Goods”, “Train Station”, “Wholesale Store”, “Zoo”, or “Other.”

An electronic display output prompts entry of a message tag for a Place Name (312) regarding the message to be conveyed. In some embodiments, the message tag for a Place Name may be the name of a business, e.g., Crème Si Bon, or Starbucks.

An electronic display output prompts entry of a message tag for an Address (316) regarding the message to be conveyed. The Address may be a street intersection, or the name of a nearby Landmark regarding the message to be conveyed. In some embodiments, the message tag for an Address may be the name of a shopping center, e.g. the Marketplace.

An electronic display output prompts entry of a message tag for the name of a City (320) regarding the message to be conveyed, e.g., San Ramon. In some embodiments, as explained below, the message tag of a City (320) regarding the message to be conveyed may be filled in automatically via instructions executed by the at least one Processing Device to acquire the geolocation sensors of the Body of Text Creation and Display Device (115).

An electronic display output prompts entry of a message tag for a State (324) for the name of a State regarding the message to be conveyed, e.g., California. In some embodiments, as explained below, the name of a State regarding the message to be conveyed may be filled in automatically via instructions executed by the at least one Processing Device to acquire the geolocation sensors of the Body of Text Creation and Display Device (115). In some embodiments, as explained below, a plurality of State names regarding the message to be conveyed may be presented along with the respective Country name for that City for selection. In instances of a country having provinces or other politician sub-jurisdictions in lieu of states, the message tag for a State (324) would be for a province or other politician jurisdiction. In instances of a countries not having states, provinces or other politician sub-jurisdictions, the message tag for a State (324) could be empty.

An electronic display output prompts entry of a message tag for a Country (328) for the name of a Country regarding the message to be conveyed, e.g., United States. In some embodiments, as explained below, the name of a State regarding the message to be conveyed may be filled in automatically via instructions executed by the at least one Processing Device to acquire the geolocation sensors of the Body of Text Creation and Display Device (115). In some embodiments, as explained above and below, a Country name may be selected by selection of the City and State regarding the message to be conveyed. In some embodiments, as explained above and below, a Country name may be selected by selection of the City without a State regarding the message to be conveyed where the geographical location lacks a State.

Show in FIG. 3C are fields for a Date (332), a Date Approximation (336), a Time (340), and a Recipient (344).

An electronic display output prompts entry of a message tag for a Date (332). In some embodiments, the message tag for the Date (332) is exact, e.g. November 1, 2015. In some embodiments, the message tag for a Date (332) may be inexact, e.g., “Weekday” or “Weekend”.

An electronic display output prompts entry of a message tag for a Date Approximation (336). Using this message tag in some embodiments, a date may be tagged to indicate less accuracy, e.g., “Around 15 days.”

An electronic display output prompts entry of a message tag for a Time (340). In some embodiments, the message tag for the Time (340) is exact, e.g., 10:15 AM. In some embodiments, the message tag for the Time is inexact, e.g., “Morning”, “Afternoon”, “Evening” or “Night”.

An electronic display output prompts entry of a message tag for a Recipient (344). In some embodiments, a user is prompted to select from a list of entries. The entries may include “Person”, or “Not a Particular Person,” the latter signifying a user can post a message to or about a group of people, or perhaps a non-person, such an animal, a non-living thing or an event.

Should a user select “Person” for a message tag for a Recipient (344), the electronic display output prompts for additional message tag regarding the Recipient.

Show in FIG. 3D are fields for a Gender (348), for an Age (352), for a Height (356), for a Body Type (360), for a Complexion (364) and for a Race (368).

An electronic display output prompts entry of a message tag for a Gender (348). In some embodiments, the message tag for Gender may be “Female” or “Male.” In some embodiments, the message tag for Gender may be “Transgender Female”, or “Transgender Male”.

Electronic display output prompts entry of a message tag for an Age (352). In some embodiments, the message tag for Age is exact, e.g., 20. In some embodiments, the message tag for an Age (352) may be inexact, e.g., “Teen-age,” “Young-age,” “Middle-Age,” or “Old-Age.” In some embodiments, the message tag for an Age (352) may be numerical, e.g., “14 to 17”, “18 to 25”, “26 to 35”, “36 to 50”, or “Over 50”. In some embodiments, as when a message regards a non-human, the message tag for Age (352) may be “Unknown.”

An electronic display output prompts entry of a message tag for a Height (356). In some embodiments, the message tag for the Height (356) is exact, e.g., 5′7″. In some embodiments, the message tag for a Height (356) may be inexact, e.g., “Short”, “Average” or “Tall”.

An electronic display output prompts entry of a message tag for a Body Type (360). In some embodiments, the message tag for the Body Type (360) may be exact or a close estimate, e.g., “about 145 lb.” In some embodiments, the message tag for a Body Type (360) may be inexact, e.g., “Slender”, “Medium” or “Heavy”.

An electronic display output prompts entry of a message tag for a Complexion (364). In some embodiments, the message tag for a Complexion (364) may be “Light”, “Medium” or “Dark”.

An electronic display output prompts entry of a message tag for a Race (368). In some embodiments, the message tag for a Race (368) maybe “White”, “Black or African American”, “American Indian or Alaska Native”, “Asian”, “Hispanic or Latino”, or “Native Hawaiian or Other Pacific Islander”.

Show in FIG. 3E are fields for a Subject (372), a Message Type (376), a Message (380), and a File Attachment (384).

An electronic display output (372) prompts entry of a message tag for a Subject. The message tag for a Subject (372) may be any body of text. Some embodiments may omit the message tag for a Subject (372).

An electronic display output prompts entry of a message tag for a Message Type (376).

In some embodiments, the message tag for a Message Type (376) may be “Acknowledgment” meaning showing gratitude towards an individual or group of people.

In some embodiments, the message tag for a Message Type (376) may be “Advise” meaning to offer genuine advice or feedback.

In some embodiments, the message tag for a Message Type (376) may be “Alert” meaning attempting to alert an individual or group of people to an event or as a precaution.

In some embodiments, the message tag for a Message Type (376) may be “Appreciation” meaning showing gratitude towards an individual or group of people.

In some embodiments, the message tag for a Message Type (376) may be “Careful” meaning an attempting to alert an individual or group of people to an event, a situation, a condition or provide a precaution.

In some embodiments, the message tag for a Message Type (376) may be “Conception” meaning to share an on any subject with an individual or group of people.

In some embodiments, the message tag for a Message Type (376) may be “Conclusion” meaning to recognize a person's or a group of people's behavior, actions, qualities etc.

In some embodiments, the message tag for a Message Type (376) may be “Consideration” meaning to recognize a person's or a group of people's behavior, actions, qualities etc.

In some embodiments, the message tag for a Message Type (376) may be “Examination” meaning to recognize a person's or a group of people's behavior, actions, qualities etc.

In some embodiments, the message tag for a Message Type (376) may be “Gratitude” meaning to show gratitude towards an individual or a group of people.

In some embodiments, the message tag for a Message Type (376) may be “Idea” meaning to share an idea on any subject to an individual or a group of people.

In some embodiments, the message tag for a Message Type (376) may be “Information” meaning to recognize a person's or a group of people's behavior, actions, qualities etc.

In some embodiments, the message tag for a Message Type (376) may be “Instruction” meaning to offer genuine advice or feedback.

In some embodiments, the message tag for a Message Type (376) may be “Invitation” meaning to invite someone or a group of people to an event or other gathering.

In some embodiments, the message tag for a Message Type (376) may be “Note” meaning to recognize a person's or a group of people's behavior, actions, qualities etc.

In some embodiments, the message tag for a Message Type (376) may be “Notion” meaning to share an idea on any subject with an individual or a group of people.

In some embodiments, the message tag for a Message Type (376) may be “Observant” meaning to attempt to alert an individual or a group of people to an event, situation, condition or to provide a precaution.

In some embodiments, the message tag for a Message Type (376) may be “Observation” meaning to recognize a person's or people's behavior, actions, qualities etc.

In some embodiments, the message tag for a Message Type (376) may be “Opinion” meaning to offer genuine advice or feedback.

In some embodiments, the message tag for a Message Type (376) may be “Perception” meaning to recognize a person's or a group of people's behavior, actions, qualities etc.

In some embodiments, the message tag for a Message Type (376) may be “Proposal” meaning to offer genuine advice or feedback.

In some embodiments, the message tag for a Message Type (376) may be “Proposition” meaning to offer genuine advice or feedback.

In some embodiments, the message tag for a Message Type (376) may be “Recognition” meaning to show gratitude towards an individual or a group of people.

In some embodiments, the message tag for a Message Type (376) may be “Recollection” meaning to show remembering memories.

In some embodiments, the message tag for a Message Type (376) may be “Recommendation” meaning to offer genuine advice or feedback.

In some embodiments, the message tag for a Message Type (376) may be “Re-Connection” or “Reconnect,” meaning to attempt to reunite with long lost contacts or temporary contacts.

In some embodiments, the message tag for a Message Type (376) may be “Review” meaning to recognize a person's or a group of people's behavior, actions, qualities etc.

In some embodiments, the message tag for a Message Type (376) may be “Study” meaning to recognize a person's or a group of people's behavior, actions, qualities etc.

In some embodiments, the message tag for a Message Type (376) may be “Suggestion” meaning to offer genuine advice or feedback.

In some embodiments, the message tag for a Message Type (376) may be “Thanks” meaning to show gratitude towards an individual or a group of people.

In some embodiments, the message tag for a Message Type (376) may be “View” meaning to recognize a person's or a group of people's behavior, actions, qualities etc.

In some embodiments, the message tag for a Message Type (376) may be “Vigilant” meaning to attempt to alert an individual or a group of people to an event, a situation, a condition or provide a precaution.

In some embodiments, the message tag for a Message Type (376) may be “Wary” meaning to attempt to alert an individual or a group of people to an event, a situation, a condition or provide a precaution.

In some embodiments, the message tag for a Message Type (376) may be “Watchful” meaning to attempt to alert an individual or a group of people to an event, a situation, a condition or provide a precaution.

An electronic display output prompts entry of Message (380). The Message (380) may be any body of text.

An electronic display output prompts entry for a File Attachment (384). A user may be prompted to select a file for attachment regarding the message to be conveyed.

If the user is complete and satisfied with the posting, then pressing the POST button send the message tags and message to the at least one Processing Device (220) for posting by the Server (215).

In embodiments in which the message tag for a Message Type (376) is “Re-Connection” or “Reconnect,” the method directs the user to the fields for an Access Question (388) and an Access Answer (392).

Show in FIG. 3F are fields for an Access Question (388) and an Access Answer (392).

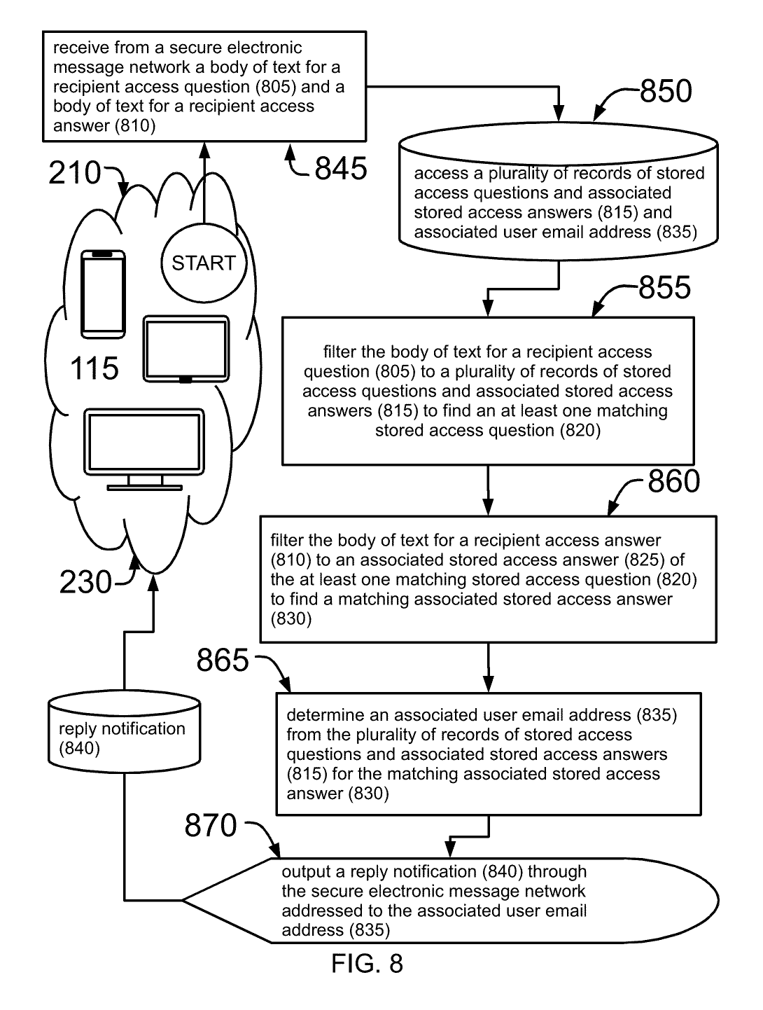

In a preferred embodiment, if the message tag for a Message Type (376) is “Re-Connection,” or “Reconnect,” a message access verification is included, such that the method defaults to prompting entry for an Access Question (388) and an Access Answer (392). See also FIG. 8. These forms of message access verification greatly increase the likelihood that conveyance of the message is discreet as only the sender and the recipient are highly likely to know the answer. Unlike identity verification questions typically used, as with financial institutions, the sender knows the answer while creating the question, and may thus use the answer to prevent access to anyone but the person to whom the message is directed. By increasing the privacy of the question to the sender and the recipient, the sender has high assurance that only the intended recipient will see the message.

An electronic display output prompts entry for an Access Question (388). In some embodiments, the Access Question (388) may be “What was the topic we talked about for over an hour?” In some embodiments, the Access Question (388) may be “Please state the name of the school we attended together.” In some embodiments, the Access Question (388) may be “Please state your hair color.” In general, the Access Question (388) is of a personal nature to assure only the sender and the recipient are highly likely to know the answer.

An electronic display output prompts entry for an Access Answer (392). As an example, an Access Answer (392) to the question “Please state the name of the school we attended together” may be Cal High.

As an example, an Access Answer (392) to the Access Question (388) “Please state your hair color” may be “none.”

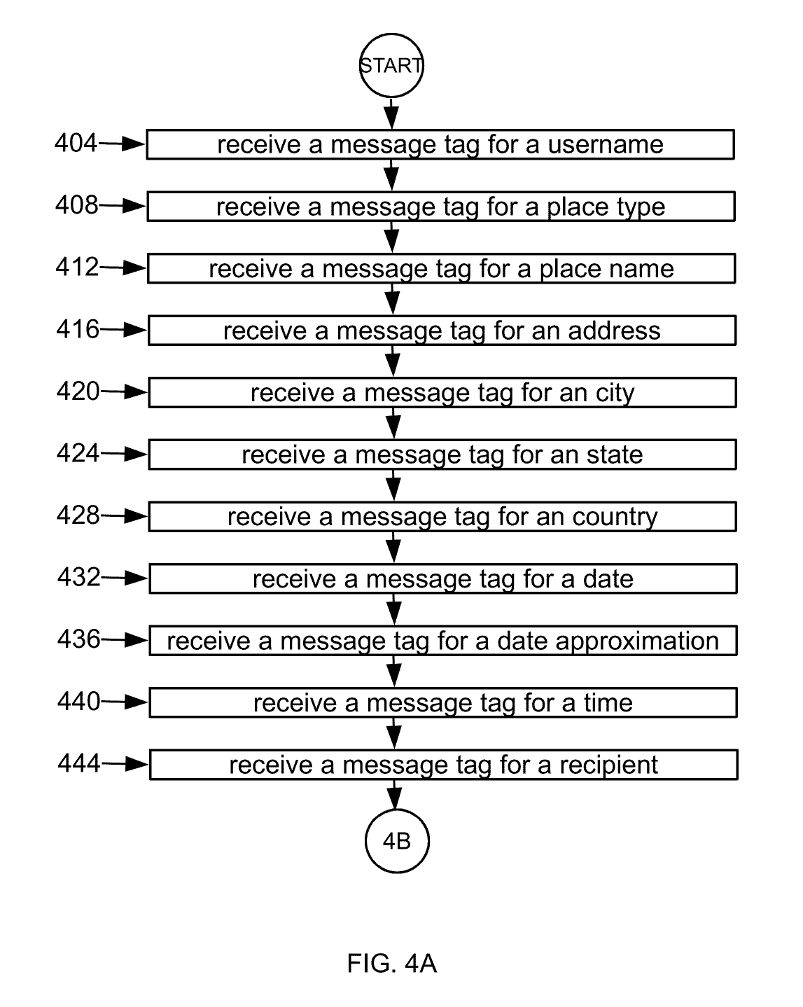

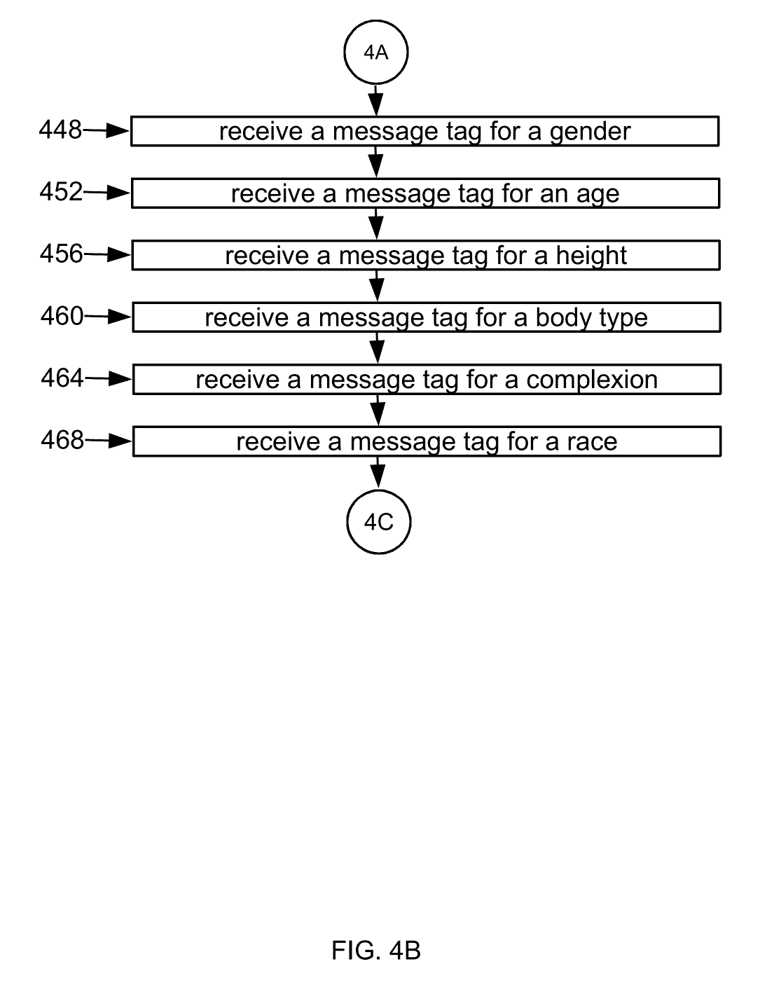

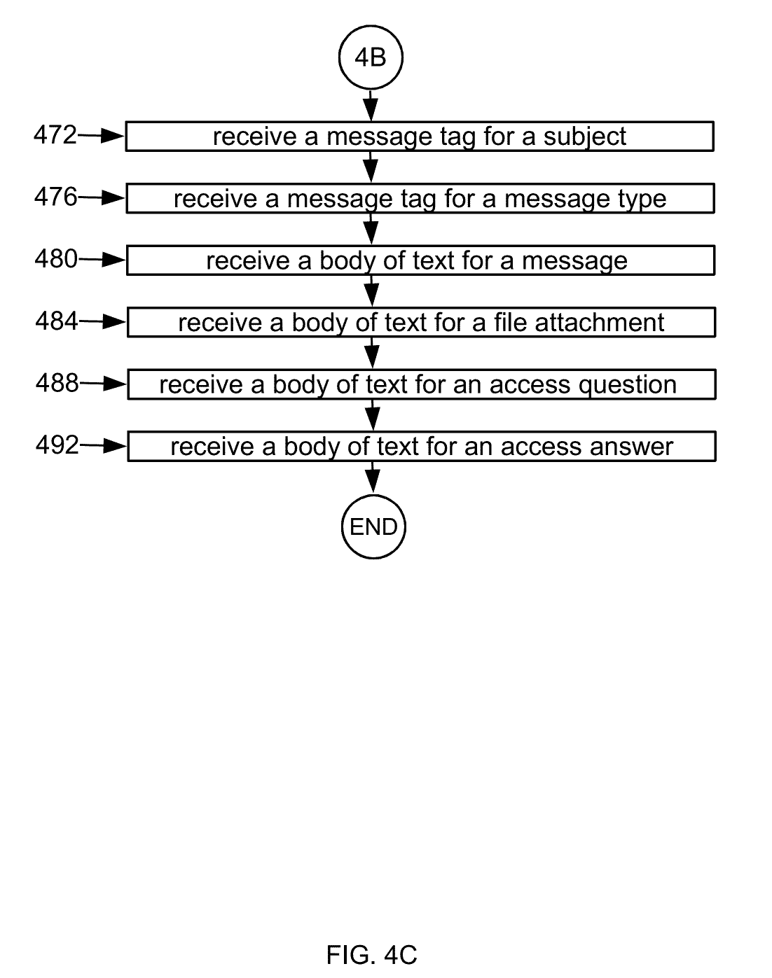

FIGS. 4A, 4B and 4C show instructions that when executed by the at least one Processing Device (220) cause the system to receive the message tags and body of text for the method.

Step 404 comprises an instruction to receive a message tag for a Username (304). An explanation of the message tag for a Username (304) is provided above.

Step 408 comprises an instruction to receive a message tag for a Place Type (308). An explanation of the message tag for a Place Type (308) is provided above.

Step 412 comprises an instruction to receive a message tag for a Place Name (312). An explanation of the message tag for a Place Name (312) is provided above.

Step 416 comprises an instruction to receive a message tag for an Address (316). An explanation of the message tag for an Address (316) is provided above.

Step 420 comprises an instruction to receive a message tag for a City (320). An explanation of the message tag for a City (320) is provided above.

Step 424 comprises an instruction to receive a message tag for a State (324). An explanation of the message tag for a State (324) is provided above.

Step 428 comprises an instruction to receive a message tag for a Country (328). An explanation of the message tag for a Country (328) is provided above.

Step 432 comprises an instruction to receive a message tag for a Date (332). An explanation of the message tag for a Date (332) is provided above.

Step 436 comprises an instruction to receive a message tag for a Date Approximation (336). An explanation of the message tag for a Date Approximation (336) is provided above.

Step 440 comprises an instruction to receive a message tag for a Time (340). An explanation of the message tag for a Time (340) is provided above.

Step 444 comprises an instruction to receive a message tag for a Recipient (344). An explanation of the message tag for a Recipient (344) is provided above.

Step 448 comprises an instruction to receive a message tag for a Gender (348). An explanation of the message tag for a Gender (348) is provided above. This Step is omitted in some embodiments.

Step 452 comprises an instruction to receive a message tag for an Age (352). An explanation of the message tag for an Age (352) is provided above. This Step is omitted in some embodiments.

Step 456 comprises an instruction to receive a message tag for a Height (356). An explanation of the message tag for a Height (356) is provided above. This Step is omitted in some embodiments.

Step 460 comprises an instruction to receive a message tag for a Body Type (360). An explanation of the message tag for a Body Type (360) is provided above. This Step is omitted in some embodiments.

Step 464 comprises an instruction to receive a message tag for a Complexion (364). An explanation of the message tag for a Complexion (364) is provided above. This Step is omitted in some embodiments.

Step 468 comprises an instruction to receive a message tag for a Race (368). An explanation of the message tag for a Race (368) is provided above. This Step is omitted in some embodiments.

Step 472 comprises an instruction to receive a message tag for a Subject (372). An explanation of the message tag for a Subject (372) is provided above. This Step is omitted in some embodiments.

Step 476 comprises an instruction to receive a message tag for a Message Type (376). An explanation of the message tag for a Message Type (376) is provided above.

Step 480 comprises an instruction to receive a body of text for a Message (380). An explanation of the body of text for a Message (380) is provided above.

Step 484 comprises an instruction to receive a body of text for a File Attachment (384). An explanation of the body of text for a File Attachment (384) is provided above. This Step is omitted in some embodiments.

Step 488 comprises an instruction to receive a body of text for an Access Question (388). An explanation of the body of text for an Access Question (388) is provided above. This Step is omitted in some embodiments.

Step 492 comprises an instruction to receive a body of text for an Access Answer (392). An explanation of the body of text for an Access Answer (392) is provided above. This Step is omitted in some embodiments.

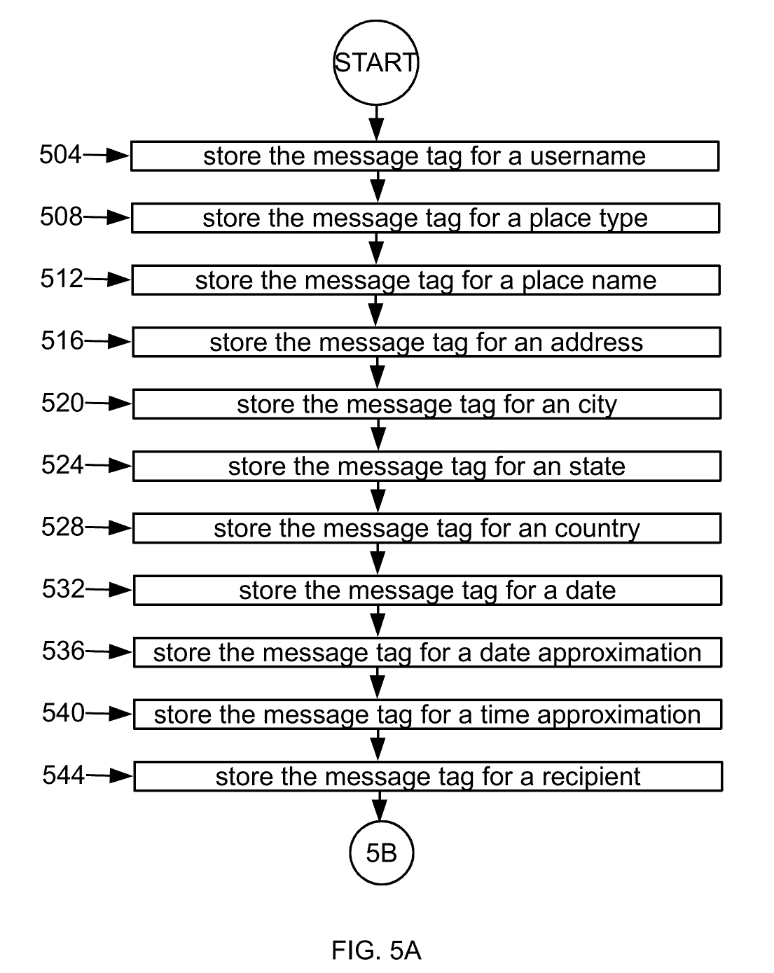

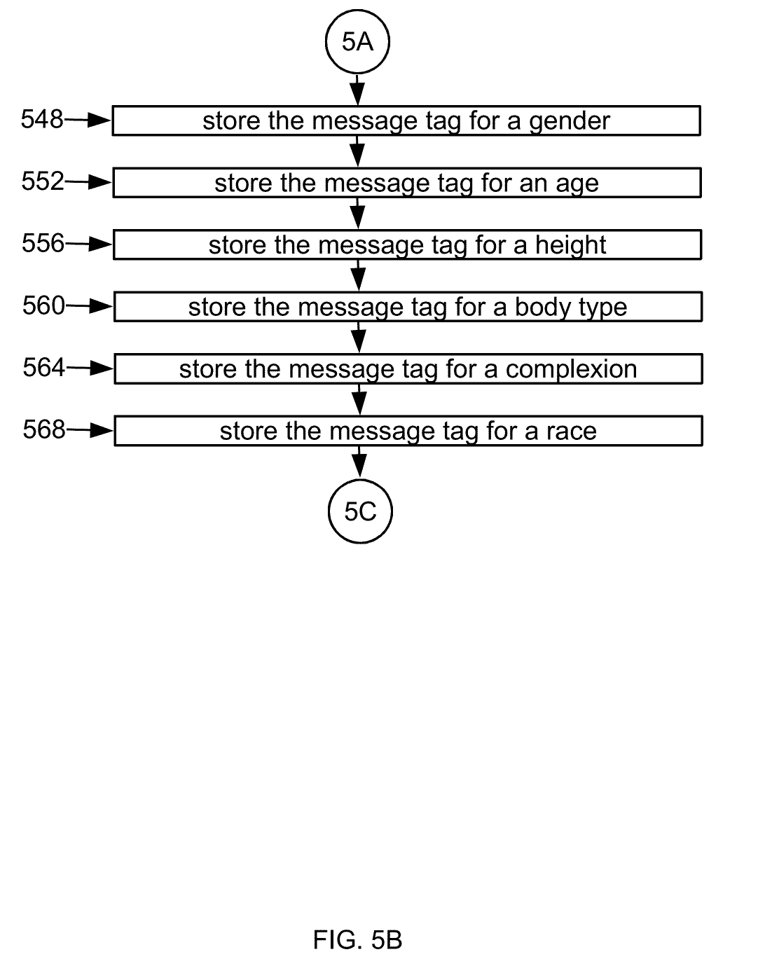

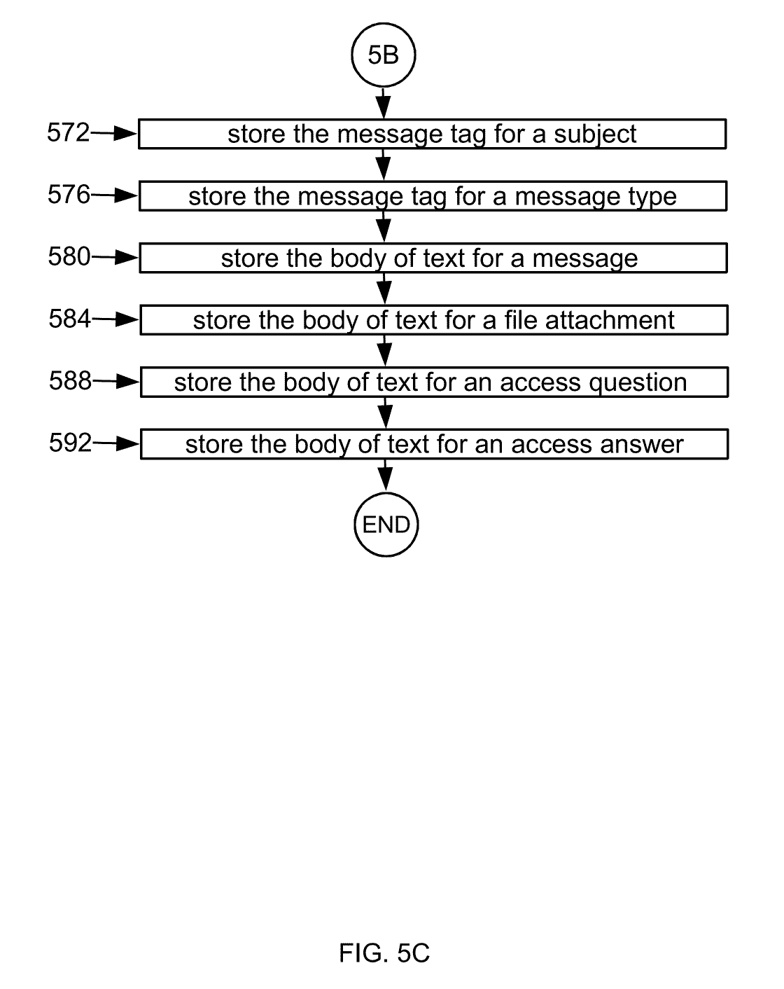

FIGS. 5A, 5B and 5C show instructions that when executed by the at least one Processing Device (220) cause the system to store the message tags and body of text for the method in the at least one non-transitory storage medium.

Step 504 comprises an instruction to store the message tag for a Username (304). An explanation of the message tag for a Username (304) is provided above.

Step 508 comprises an instruction to store the message tag for a Place Type (308). An explanation of the message tag for a Place Type (308) is provided above.

Step 512 comprises an instruction to store the message tag for a Place Name (312). An explanation of the message tag for a Place Name (312) is provided above.

Step 516 comprises an instruction to store the message tag for an Address (316). An explanation of the message tag for an Address (316) is provided above.

Step 520 comprises an instruction to store the message tag for a City (320). An explanation of the message tag for a City (320) is provided above.

Step 524 comprises an instruction to store the message tag for a State (324). An explanation of the message tag for a State (324) is provided above.

Step 528 comprises an instruction to store the message tag for a Country (328). An explanation of the message tag for a Country (328) is provided above.

Step 532 comprises an instruction to store the message tag for a Date (332). An explanation of the message tag for a Date (332) is provided above.

Step 536 comprises an instruction to store the message tag for a Date Approximation (336). An explanation of the message tag for a Date Approximation (336) is provided above.

Step 540 comprises an instruction to store the message tag for a Time (340). An explanation of the message tag for a Time (340) is provided above.

Step 544 comprises an instruction to store the message tag for a Recipient (344). An explanation of the message tag for a Recipient (344) is provided above.

Step 548 comprises an instruction to store the message tag for a Gender (348). An explanation of the message tag for a Gender (348) is provided above. This Step is omitted in some embodiments.

Step 552 comprises an instruction to store the message tag for an Age (352). An explanation of the message tag for an Age (352) is provided above. This Step is omitted in some embodiments.

Step 556 comprises an instruction to store the message tag for a Height (356). An explanation of the message tag for a Height (356) is provided above. This Step is omitted in some embodiments.

Step 560 comprises an instruction to store the message tag for a Body Type (360). An explanation of the message tag for a Body Type (360) is provided above. This Step is omitted in some embodiments.

Step 564 comprises an instruction to store the message tag for a Complexion (364). An explanation of the message tag for a Complexion (364) is provided above. This Step is omitted in some embodiments.

Step 568 comprises an instruction to store the message tag for a Race (368). An explanation of the message tag for a Race (368) is provided above. This Step is omitted in some embodiments.

Step 572 comprises an instruction to store the message tag for a Subject (372). An explanation of the message tag for a Subject (372) is provided above. This Step is omitted in some embodiments.

Step 576 comprises an instruction to store the message tag for a Message Type (376). An explanation of the message tag for a Message Type (376) is provided above.

Step 580 comprises an instruction to store the body of text for a Message (380). An explanation of the body of text for a Message (380) is provided above.

Step 584 comprises an instruction to store the body of text for a File Attachment (384). An explanation of the body of text for a File Attachment (384) is provided above. This Step is omitted in some embodiments.

Step 588 comprises an instruction to store the body of text for an Access Question (388). An explanation of the body of text for an Access Question (388) is provided above. This Step is omitted in some embodiments.

Step 592 comprises an instruction to store the body of text for an Access Answer (392). An explanation of the body of text for an Access Answer (392) is provided above. This Step is omitted in some embodiments.

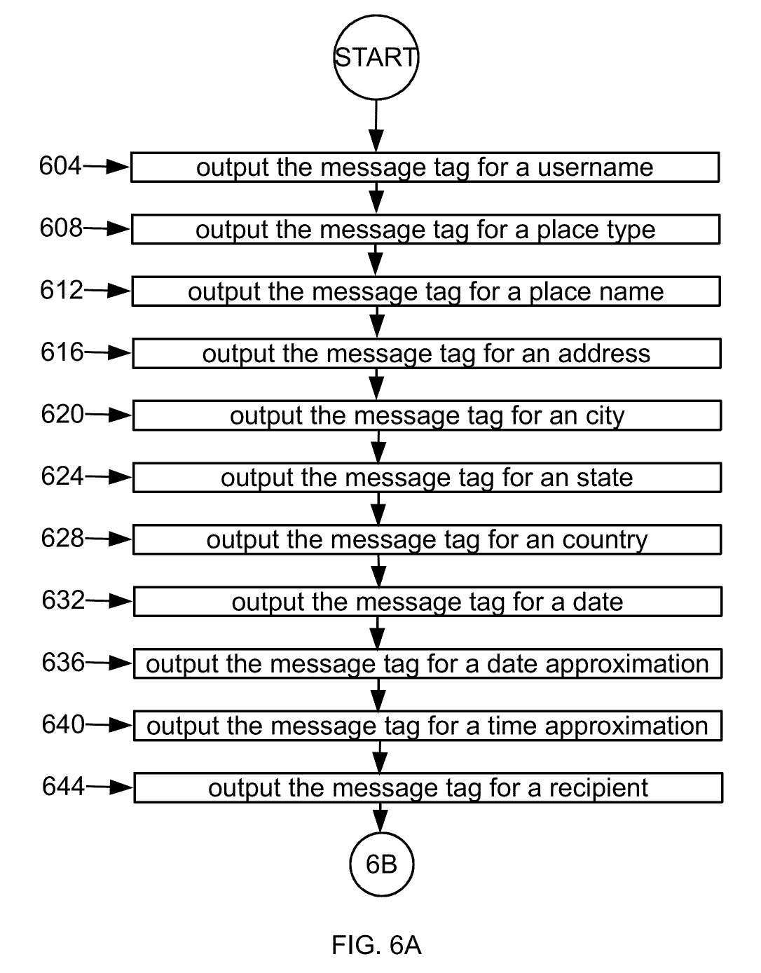

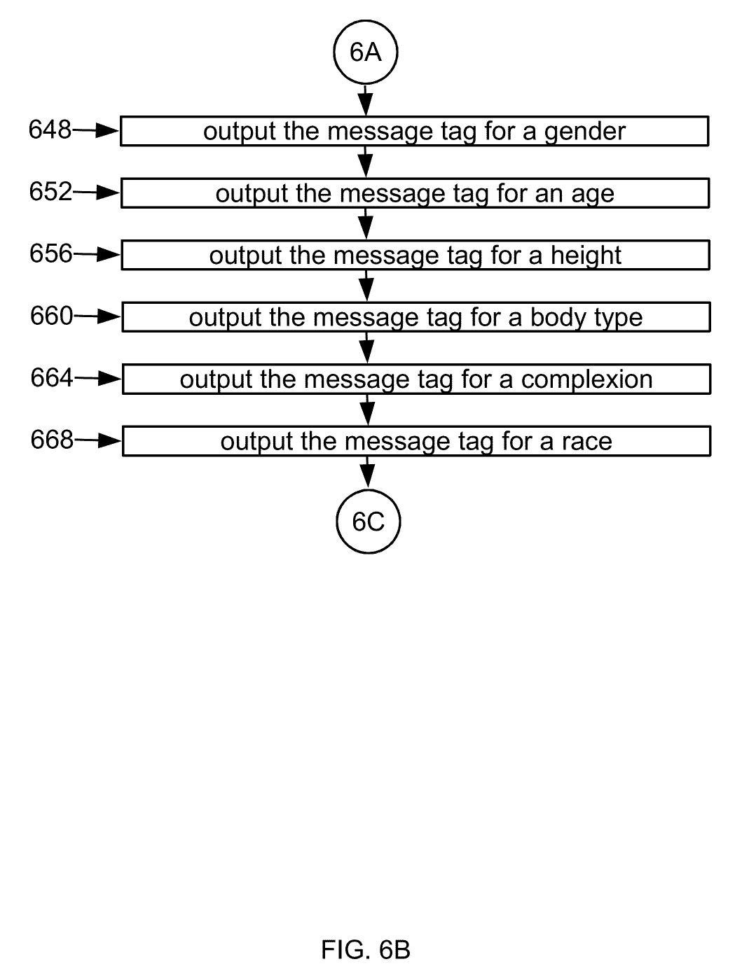

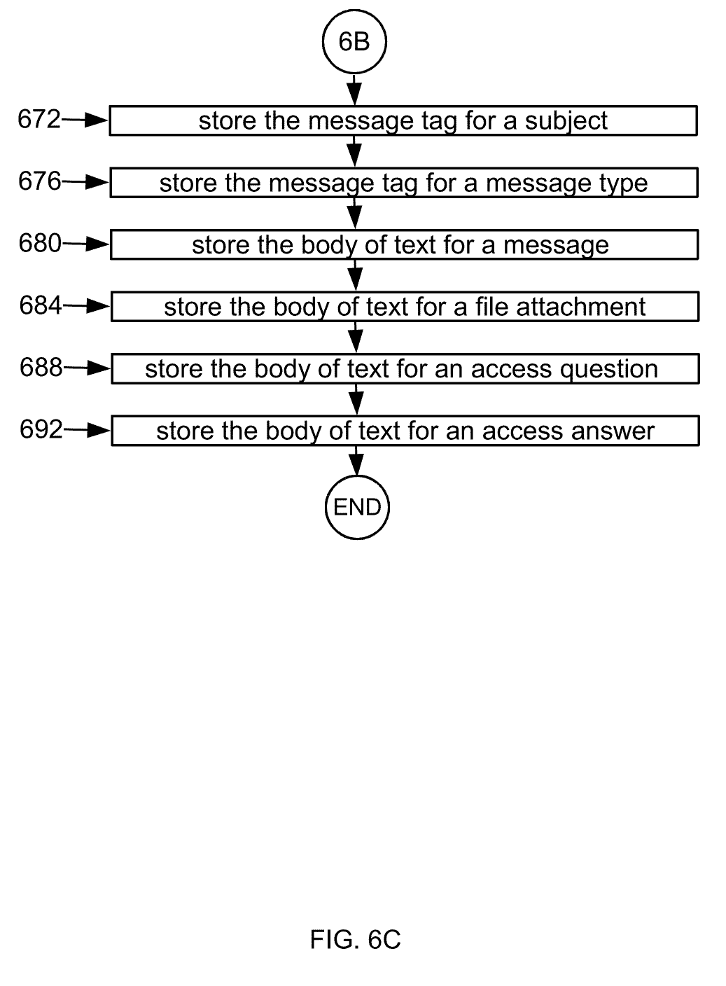

FIGS. 6A, 6B and 6C show instructions that when executed by the at least one Processing Device (220) cause the system to output through a body of text electronic distribution network for public display the message tags and body of text for the method.

Step 604 comprises an instruction to output the message tag for a Username (304) through a body of text electronic distribution network for public display. An explanation of the message tag for a Username (304) is provided above.

Step 608 comprises an instruction to output the message tag for a Place Type (308) through a body of text electronic distribution network for public display. An explanation of the message tag for a Place Type (308) is provided above.

Step 612 comprises an instruction to output the message tag for a Place Name (312) through a body of text electronic distribution network for public display. An explanation of the message tag for a Place Name (312) is provided above.

Step 616 comprises an instruction to output the message tag for an Address (316) through a body of text electronic distribution network for public display. An explanation of the message tag for an Address (316) is provided above.

Step 620 comprises an instruction to output the message tag for a City (320) through a body of text electronic distribution network for public display. An explanation of the message tag for a City (320) is provided above.

Step 624 comprises an instruction to output the message tag for a State (324) through a body of text electronic distribution network for public display. An explanation of the message tag for a State (324) is provided above.

Step 628 comprises an instruction to output the message tag for a Country (328) through a body of text electronic distribution network for public display. An explanation of the message tag for a Country (328) is provided above.

Step 632 comprises an instruction to output the message tag for a Date (332) through a body of text electronic distribution network for public display. An explanation of the message tag for a Date (332) is provided above.

Step 636 comprises an instruction to output the message tag for a Date Approximation (336) through a body of text electronic distribution network for public display. An explanation of the message tag for a Date Approximation (336) is provided above.

Step 640 comprises an instruction to output the message tag for a Time (340) through a body of text electronic distribution network for public display. An explanation of the message tag for a Time (340) is provided above.

Step 644 comprises an instruction to output the message tag for a Recipient (344) through a body of text electronic distribution network for public display. An explanation of the message tag for a Recipient (344) is provided above.

Step 648 comprises an instruction to output the message tag for a Gender (348) through a body of text electronic distribution network for public display. An explanation of the message tag for a Gender (348) is provided above.

Step 652 comprises an instruction to output the message tag for an Age (352). An explanation of the message tag for an Age (352) is provided above.

Step 656 comprises an instruction to output the message tag for a Height (356) through a body of text electronic distribution network for public display. An explanation of the message tag for a Height (356) is provided above.

Step 660 comprises an instruction to output the message tag for a Body Type (360) through a body of text electronic distribution network for public display. An explanation of the message tag for a Body Type (360) is provided above.

Step 664 comprises an instruction to output the message tag for a Complexion (364) through a body of text electronic distribution network for public display. An explanation of the message tag for a Complexion (364) is provided above.

Step 668 comprises an instruction to output the message tag for a Race (368) through a body of text electronic distribution network for public display. An explanation of the message tag for a Race (368) is provided above.

Step 672 comprises an instruction to output the message tag for a Subject (372) through a body of text electronic distribution network for public display. An explanation of the message tag for a Subject (372) is provided above.

Step 676 comprises an instruction to output the message tag for a Message Type (376) through a body of text electronic distribution network for public display. An explanation of the message tag for a Message Type (376) is provided above.

Step 680 comprises an instruction to output the body of text for a Message (380) through a body of text electronic distribution network for public display. An explanation of the body of text for a Message (380) is provided above.

Step 684 comprises an instruction to output the body of text for a File Attachment (384) through a body of text electronic distribution network for public display. An explanation of the body of text for a File Attachment (384) is provided above.

Step 688 comprises an instruction to output the body of text for an Access Question (388) through a body of text electronic distribution network for public display. An explanation of the body of text for an Access Question (388) is provided above.

Step 692 comprises an instruction to output the body of text for an Access Answer (392) through a body of text electronic distribution network for public display. An explanation of the body of text for an Access Answer (392) is provided above.

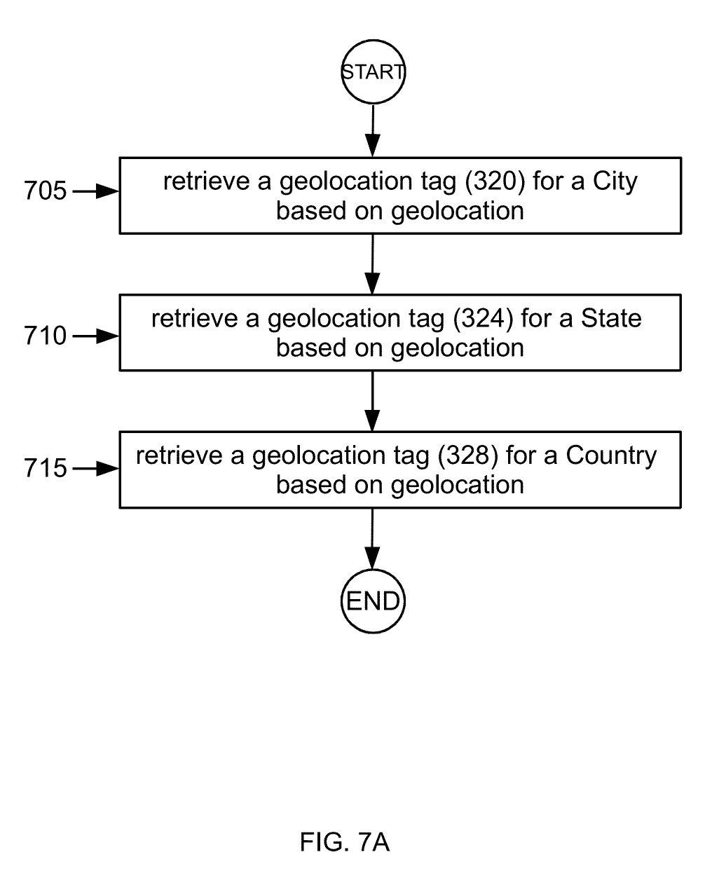

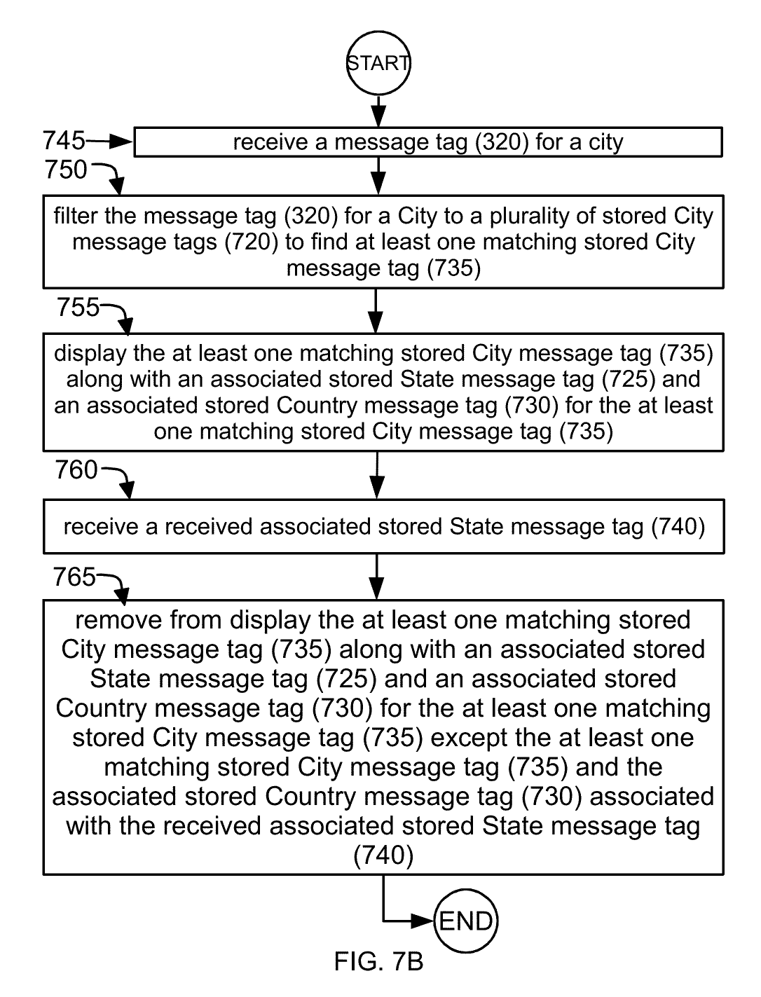

FIGS. 7A and 7B show instructions that when executed by the at least one Processing Device (220) cause the system to determine the City, State, and Country location of the origin of the Message (380) through the location of the input device.

FIG. 7A shows an embodiment in which instructions that when executed by the at least one Processing Device (220) cause the system to acquire the geolocation of the input device from the Global Positioning System hardware within the input device and to populate the message tags for a City, a State, and a Country.

Step 705 comprises an instruction to retrieve a message tag for a City (320) based on geolocation. With this instruction, the method directs the at least one Processing Device (220) to acquire the geolocation (City, State and Country) of the input device from the Global Positioning System hardware within the input device and populate the message tag for a City (320).

Step 710 comprises an instruction to retrieve a message tag for a State (324) based on geolocation. With this instruction, the method directs the at least one Processing Device (220) to acquire the geolocation of the input device from the Global Positioning System hardware within the input device and populate the message tag for a State (324).

Step 715 comprises an instruction to retrieve a message tag for a Country (328) based on geolocation. With this instruction, the method directs the at least one Processing Device (220) to acquire the geolocation of the input device from the Global Positioning System hardware within the input device and populate the message tag for a Country (328).

FIG. 7B shows an embodiment in which instructions that when executed by the at least one Processing Device (220) cause the system to acquire the location of the input device from an initial entry of a message tag for a City (320), and then display a plurality of State and Country message tags having in common the name of the entered City, from which a user may select the State and Country. In instances in which the City is located in a geographical area lacing States, the plurality of States and Country message tags will display just a Country.

As shown in FIG. 7 are a plurality of message tags, specifically, a plurality of stored City message tags (720), with each stored City message tag (720) having a stored associated State message tag (725) and a stored associated Country message tag (730).

As shown in FIG. 3A, the electronic display output prompts entry of a message tag for a City (320) for the name of a City regarding the message to be conveyed. Returning to FIG. 7B, on entry of a City name, the at least one Processing Device (220) filters (compares) the message tag for a City (320) against (to) a database of a plurality of stored City message tags (720). On finding at least one matching stored City message tag (735), the at least one Processing Device (220) pulls the stored associated State message tag (725) and the stored associated Country message tag (730) and populates the message tag (325) for a State and the message tag (330) for a Country. By Steps, the instructions are as follows.

Step 745 comprises an instruction to receive a message tag for a City (320).

Step 750 comprises an instruction to filter the message tag for a City (320) to a plurality of stored City message tags (720) to find at least one matching stored City message tag (735).

Step 755 comprises an instruction to display the at least one matching stored City message tag (735) along with an associated stored State message tag (725) and an associated stored Country message tag (730) for the at least one matching stored City message tag (735).

Step 760 comprises an instruction to receive a received associated stored State message tag (740), meaning the user has indicated which State is the correct State. At this stage, the at least one Processing Device (220) has the complete City, State and Country location since there is typically only one city per State with that specific name.

Step 765 comprises an instruction to remove from display remove from display the at least one matching stored City message tag (735) along with an associated stored State message tag (725) and an associated stored Country message tag (730) for the at least one matching stored City message tag (735) except the at least one matching stored City message tag (735) and the associated stored Country message tag (730) associated with the received associated stored State message tag (740).

FIG. 8 shows an embodiment in which instructions that when executed by the at least one Processing Device (220) cause the system to use message access verification using the fields shown FIG. 3F. In a preferred embodiment, message access verification is used when the message type is Re-connect.

This form of message access verification greatly increases the likelihood that conveyance of the message is discreet as only the recipient are highly likely to know the access answer to the access question used by the sender. Unlike typical identity verification questions, the sender knows the answer while creating the question, and may thus use the answer to prevent access to anyone but the person to whom the message is directed.

As shown in FIG. 8, there are a plurality of information fields, which being are longer than one word or name, are referred to as a body of test. These are, specifically, a body of text for a recipient access question (805), a body of text for a recipient access answer (810), a plurality of records of stored access questions and associated stored access answers (815), which are queried to find an at least one matching stored access question (820), and an associated stored access answer (825) for the at least one matching stored access question (820), an associated user email address (835), and a reply notification (840).

When a reader of a post wishes to reply to a Re-connect post, the reader opens a Reply window, which shows the fields shown in FIG. 3F. When the reader completes the access answer and clicks Reply, the method in the Body of Text Creation and Display Device (115) transmits the body of text for a recipient access question (805) and a body of text for a recipient access answer (810) to the at least one Processing Device (220) in the Server (215).

At Step 845, the at least one Processing Device (220) receives a body of text for a recipient access question (805) and a body of text for a recipient access answer (810).

At Step 850, the at least one Processing Device (220) then accesses a database of a plurality of records of stored access questions and associated stored access answers (815). These are the records of the Access Question (388) and the Access Answer (392) created by people posting to Convey a Message. As indicated by FIG. 8, the records also contain an associated user email address (835), i.e., the poster's email address.

At Step 855 the at least one Processing Device (220) then filter (compares) the body of text for a recipient access question (805) to the plurality of records of stored access questions and associated stored access answers (815) to find an at least one matching stored access question (820).

Having found at least one matching question, then at least one Processing Device (220) then moves to Step 860, at which the at least one Processing Device (220) filters (compares) the body of text for a recipient access answer (810) to an associated stored access answer (825) of the at least one matching stored access question (820) to find a matching associated stored access answer (830). If the recipient access answer (810) matches the associated stored access answer (825) (of the at least one matching stored access question (820), then the at least one Processing Device (220) moves to the next step.

If there is not a match, then the at least one Processing Device (220) looks through the remaining associated stored access answers (825). If there is not match, the at least one Processing Device (220) defaults to a suitable message.

Presuming now that the body of text for the recipient access question (805) and the body of text for a recipient access answer (810) match the at least one matching stored access question (820) and its matching associated stored access answer (830), then the at least one Processing Device (220) moves to Step 865 to again access the database of a plurality of records of stored access questions and associated stored access answers (815), this time to determine an associated user email address (835) from the record of the at least one matching stored access question (820) and the matching associated stored access answer (830).

At step 870, on determining the associated user email address (835) from the record, the at least one Processing Device (220) sends a reply notification (840) through the secure electronic message network to the associated user email address (835). The associated user email address (835) provides a point of contact to the person posting the message so that the person posting the message may receive a notice that their intended recipient has received the message and desires to have a two-way conversation.

Thereupon, the poster of the original message and the recipient may continue to use the method to convey a message, or determine their own method of communication.

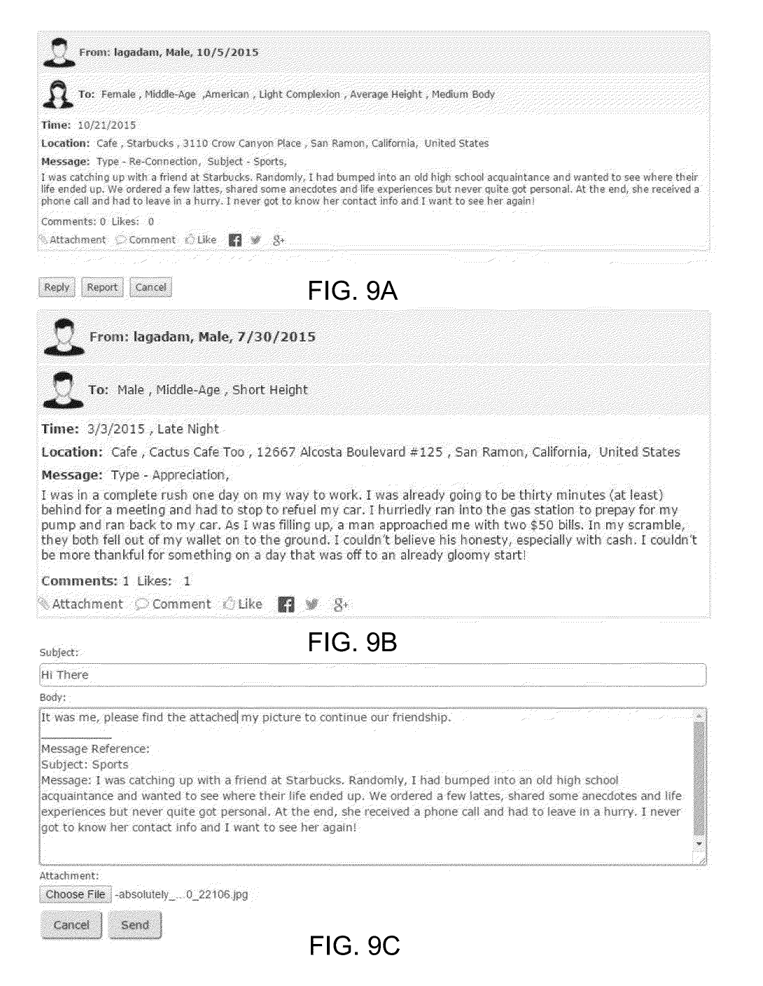

FIGS. 9A, 9B and 9C show exemplary postings created from the method.

FIGS. 9A and 9B show examples of postings to convey a message anonymously and discreetly.

Another example might be:

Message Type: Appreciation:

“I was in a complete rush one day on my way to work. I was already going to be thirty minutes (at least) behind for a meeting and had to stop to refuel my car. I hurriedly ran into the gas station to prepay for my pump and ran back to my car. As I was filling up, a woman approached me with two $50 bills. In my scramble, they both fell out of my wallet on to the ground. I couldn't believe her honesty, especially with cash. I couldn't be more thankful for something on a day that was off to an already gloomy start!”

Another example might be: Message Type: Alert:

“It begins as a simple gesture and goes on to developing an act of kindness which ultimately focuses on the betterment of society as well as mankind. One day as I was driving over to a friend s I thought to stop by for gas. As I was filling my car up, I looked around casually, just in time to catch a white Corolla getting out of the parking of the tuck shop. The driver was in a hurry and when in reverse gear he scratched the red Mustang resting next to it. Upon realizing his mistake, he immediately put the car in first gear and drove past me. Everything happened so suddenly that I hardly could get the first two letters of the license plate. I was angry at the driver for not leaving a sorry note or waiting up for the Mustang driver to apologize. A day before I heard about this great app convey message which can help in catching cars. Had I known about this ConveyMessage app before, I would have jotted down the numbers of the license plate and gave it to the Mustang guy so that he could catch the driver of that Corolla.”

FIG. 9C shows an example of a reply to a posting to convey a message anonymously and discreetly.

These descriptions and drawings are embodiments and teachings of the disclosure. All variations are within the spirit and scope of the disclosure. This disclosure is not to be considered as limiting the claims to only the embodiments illustrated or discussed. Certain changes can be made in the subject matter without departing from the spirit and the scope of this invention. It is realized that changes are possible within the scope of this invention and it is further intended that each structure or element recited in any of the claims is to be understood as referring to all equivalent structure or elements. The following claims are intended to cover the invention as broadly as possible in whatever form it may be used.

I claim:

1) A system for anonymously distributing a digital message comprising at least one non-transitory storage medium (225), at least one processing device (220), wherein the at least one non-transitory storage medium (225) comprises instructions that when executed by the at least one processing device (220) cause the system to:
receive a message tag for a Place Type (308),
receive a message tag for a Place Name (312),
receive a message tag for an Address (316),
receive a message tag for a City (320),
receive a message tag for a State (324),
receive a message tag for a Country (328),
receive a message tag for a Date (332),
receive a message tag for a Time (340),
receive a message tag for a Recipient (344),
receive a message tag for a Message Type (376),
receive a body of text for a Message (380),
store the message tag for a Place Type (308) in the at least one non-transitory storage medium,
store the message tag for a Place Name (312) in the at least one non-transitory storage medium,
store the message tag for an Address (316) in the at least one non-transitory storage medium,
store the message tag for an City (320) in the at least one non-transitory storage medium,
store the message tag for an State (324) in the at least one non-transitory storage medium,
store the message tag for an Country (328) in the at least one non-transitory storage medium,
store the message tag for a Date (332) in the at least one non-transitory storage medium,
store the message tag for a Time (340) in the at least one non-transitory storage medium,
store the message tag for a Recipient (344) in the at least one non-transitory storage medium,
store the message tag for a Message Type (376) in the at least one non-transitory storage medium,
store the body of text for a Message (380) in the at least one non-transitory storage medium,
output through a body of text electronic distribution network for public display the message tag for a Place Type (308),
output through a body of text electronic distribution network for public display the message tag for a Place Name (312),
output through a body of text electronic distribution network for public display the message tag for an Address (316),
output through a body of text electronic distribution network for public display the message tag for a City (320),
output through a body of text electronic distribution network for public display the message tag for a State (324),
output through a body of text electronic distribution network for public display the message tag for a Country (328),
output through a body of text electronic distribution network for public display the message tag for a Date (332),
output through a body of text electronic distribution network for public display the message tag for a Time (340),
output through a body of text electronic distribution network for public display the message tag for a Recipient (344),
output through a body of text electronic distribution network for public display the message tag for a Message Type (376),
output through a body of text electronic distribution network for public display the body of text for a Message (380).

2) The system for anonymously distributing a digital message of claim 1 further comprising a plurality of instructions to:
receive a message tag for a username (304),
store the message tag for a username (304) in the at least one non-transitory storage medium, and
output the message tag for a username (304) through a body of text electronic distribution network for public display.

3) The system for anonymously distributing a digital message of claim 1 further comprising a plurality of instructions to
receive a message tag for a gender (348),
receive a message tag for an age (352),
receive a message tag for a height (356),
receive a message tag for a body type (360),
receive a message tag for a complexion (364),
receive a message tag for a race (368),
store the message tag for a gender (348) in the at least one non-transitory storage medium,
store the message tag for an age (352) in the at least one non-transitory storage medium,
store the message tag for a height (356) in the at least one non-transitory storage medium,
store the message tag for a body type (360) in the at least one non-transitory storage medium,
store the message tag for a complexion (364) in the at least one non-transitory storage medium,
store the message tag for a race (368) in the at least one non-transitory storage medium,
output through a body of text electronic distribution network for public display the message tag for a gender (348),
output through a body of text electronic distribution network for public display the message tag for an age (352),
output through a body of text electronic distribution network for public display the message tag for a height (356),
output through a body of text electronic distribution network for public display the message tag for a body type (360),
output through a body of text electronic distribution network for public display the message tag for a complexion (364), and
output through a body of text electronic distribution network for public display the message tag for a race (368).

4) The system for anonymously distributing a digital message of claim 1 further comprising a plurality of instructions to:
receive a file attachment (375),
store the file attachment (375) in the at least one non-transitory storage medium,
and output the file attachment (375) through a body of text electronic distribution network for public display.

5) The system for anonymously distributing a digital message of claim 1 further comprising a plurality of instructions to:
receive an access question (388),
receive an access answer (392),
store the access question (388) in the at least one non-transitory storage medium,
store the access answer (392) in the at least one non-transitory storage medium, and
output the access question (388) through a body of text electronic distribution network for public display.

6) The system for anonymously distributing a digital message of claim 1 further comprising
an instruction to retrieve a message tag for a City (320) based on geolocation,
an instruction to retrieve a message tag for a State (324) based on geolocation, and
an instruction to retrieve a message tag for a Country (328) based on geolocation.

7) The system for anonymously distributing a digital message of claim 1 further comprising a plurality of instructions to:
receive a message tag for a City (320),
filter the message tag for a City (320) to a plurality of stored City message tags (720) to find at least one matching stored City message tag (735),
display the at least one matching stored City message tag (735) and an associated stored State message tag (725) and an associated stored Country message tag (730) to the at least one matching stored City message tag (735),
receive a received associated stored State message tag (740), and
remove from display the at least one matching stored City message tag (735) and the associated stored State message tag (725) and the associated stored Country message tag (730) of the at least one matching stored City message tag (735) except the at least one matching stored City message tag (735) and the associated stored Country message tag (730) associated with the received associated stored State message tag (740).

8) The system for anonymously distributing a digital message of claim 1 wherein the message tag for a Message Type (376) is “Alert.”

9) The system for anonymously distributing a digital message of claim 1 wherein the message tag for a Message Type (376) is “Watchful.”

10) The system for anonymously distributing a digital message of claim 1 wherein the message tag for a Message Type (376) is “Appreciation.”

11) The system for anonymously distributing a digital message of claim 1 wherein the message tag for a Message Type (376) is “Recollection.”

12) The system for anonymously distributing a digital message of claim 1 wherein the message tag for a Message Type (376) is “Thanks.”

13) The system for anonymously distributing a digital message of claim 1 wherein the message tag for a Message Type (376) is “Observation.”

14) The system for anonymously distributing a digital message of claim 1 wherein the message tag for a Message Type (376) is “Review.”

15) The system for anonymously distributing a digital message of claim 1 wherein the message tag for a Message Type (376) is “Re-Connection.”

16) The system for anonymously distributing a digital message of claim 1 wherein the message tag for a Message Type (376) is “Suggestion.”

17) The system for anonymously distributing a digital message of claim 1 wherein the message tag for a Message Type (376) is “Advise.”

18) The system for anonymously distributing a digital message of claim 1 wherein the message tag for a Message Type (376) is “Proposal.”

19) The system for anonymously distributing a digital message of claim 1 wherein the message tag for the Time is selected from the group consisting of “Morning”, “Afternoon”, “Evening” and “Night.”

20) The system for anonymously distributing a digital message of claim 1 wherein the message tag for the Place Type is selected from the group consisting of “Coffee Shop”, “at the corner of”, “Internet Café”, “In Transit”, and “Other”.

21) A system for discreetly distributing a digital message comprising at least one non-transitory storage medium; and at least one processing device, wherein the at least one non-transitory storage medium comprises instructions that when executed by the at least one processing device cause the system to:
receive through a secure electronic message network (210, 230) a body of text for a recipient access question (805), and a body of text for a recipient access answer (810),
access a plurality of records of stored access questions and associated stored access answers (815),
filter the body of text for a recipient access question (805) to the plurality of records of stored access questions and associated stored access answers (815) to find an at least one matching stored access question (820),
filter the body of text for a recipient access answer (810) to an associated stored access answer (825) the at least one matching stored access question (820) to find a matching associated stored access answer (830),
determine an associated user email address (835) from the plurality of records of stored access questions and associated stored access answers (815) for the matching associated stored access answer (830),
and
output a reply notification (840) through the secure electronic message network (210, 230) addressed to the associated user email address (835).
